(19) United States
(12) Patent Application Publication
(10) Pub. No.: US 2014/0272257 A1
(43) Pub. Date: Sep. 18, 2014

(54) PLASTIC OBJECT WITH INNER PATTERN

(71) Applicant: CHIN-SHENG YANG, Tainan City (TW)

(72) Inventor: CHIN-SHENG YANG, Tainan City (TW)

(21) Appl. No.: 13/802,782

(22) Filed: Mar. 14, 2013

(51) Int. Cl. F21V 33/00; B29D 22/00

(52) U.S. Cl. CPC F21V 33/0028; B29D 22/00
USPC 428/80; 428/156; 428/188

(57) ABSTRACT

A plastic object with inner pattern is provided, including: a light-transmittable main body, monolithically formed by injection blow molding, having at least an outer surface and an inner surface, wherein the outer surface is smooth and the inner surface has predefined pattern. Because the process used by the present invention inserts a mold core with predefined pattern so that the patterns on the mold core can be formed on the inner surface of the monolithically formed object manufactured during the blow molding process. As such, the problems of complex and time-consuming steps and poor economical result associated with conventional techniques are improved.

### (a) TECHNICAL FIELD OF THE INVENTION

The present invention generally relates to an injection blow molding object, and more particularly to an injection blow molding able to create predefined pattern on an inner surface in an injection blow molding monolithic manufacturing process.

### (b) DESCRIPTION OF THE PRIOR ART

The conventional blow molding is to place an extruder mechanism on a mold. The process is to extrude a thermoplastic pipe melted in the extruder mechanism downward to the mold until the thermoplastic pipe is completely inside the mold, and then close the mold so hold the thermoplastic pipe inside the mold. Then, the air is blown into the thermoplastic pipe so that the air pressure can expand the thermoplastic pipe like a balloon until contacting the inner surface of the mold. After cooling, a hollow object having the shape of the inner surface of the mold can be manufactured.

Therefore, the conventional blow molding is for manufacturing hollow thin objects, such as, bottles, pipe, garbage can, gas can, and so on. However, in practice, the blow molding objects usually have flowing marks of plastic on the surface so that the quality appears coarse and have poor yield rate. Thus, the blow molding process is not used in manufacturing objects with fine and delicate patterns, shallow convex or shallow concave on the surface.

However, to overcome the above shortcoming, many plastic manufacturers use injection to manufacture the hollow thin objects and then use etching, transferring or electroplating process to further process on the inner surface of the object. The two-process manufacturing is not only time-consuming but also has poor yield rate. Thus, the conventional two-process manufacturing is not economically viable and the manufacturing of such object is often prohibitive to the manufacturer.

### SUMMARY OF THE INVENTION

The primary purpose of the present invention is to solve the problems of the inability of the conventional blow molding to manufacture objects with inner patterns and the problems of time consumption and poor yield rate associated with the injection molding.

Thus, to achieve the above object, the present invention is to use an injection blow molding process, which mainly inserts a mold core with predefined pattern into a plastic melt inside mold after the plastic melt is extruded into the mold and before the mold is closed for blowing. With the mold core placed inside the mold, the patterns on the mold core can be formed on the inner surface of the monolithically formed object manufactured during the blow molding process.

The present invention is to the plastic object with inner pattern manufactured by the above process, the object including: a light-transmittable main body, monolithically formed by injection blow molding, having at least an outer surface and an inner surface, wherein the outer surface being smooth and the inner surface having predefined pattern.

According to another preferable embodiment of the present invention, the pattern is continuous.

According to another preferable embodiment of the present invention, the inner surface of the main body surrounds to form a hollow part.

According to another preferable embodiment of the present invention, the main body is a light tube for electronic candle.

According to another preferable embodiment of the present invention, the main body is a spherical structure object.

According to another preferable embodiment of the present invention, the main body is a shell of a light bulb and the pattern is disposed at the lower half of the shell.

The feature and the benefit of the present invention are:

Because the present invention uses injection blow molding to form monolithic object to eliminate the complexity and time-consumption problems associated with the conventional two-process manufacturing, the yield rate and the economical benefit are both improved.

As the inner pattern on the object of the present invention can effectively reflect light, the present invention can enhance luminance and decorative values when applied to decorative products or lamps.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart of a manufacturing method for a plastic object with inner pattern according to the present invention.

FIG. 2 is a perspective diagram of the main body according to the present invention.

FIG. 3 is a dissected perspective diagram of the main body of the present invention applied to a light tube of electronic candle.

FIG. 4 is a perspective diagram of the main body of the present invention applied to a spherical structure object.

FIG. 5 is a perspective diagram of the main body of the present invention applied to a decorative aquatic ball.

FIG. 6 is a perspective diagram of the main body of the present invention applied to a shell of light bulb.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

FIG. 1 shows a flowchart of a manufacturing method for a plastic object with inner pattern according to the present invention. The method mainly inserts a mold core (1) with predefined pattern into a plastic melt (2) inside a mold (not shown) after the plastic melt (2) is extruded into the mold and before the mold is closed for blowing. With the mold core (1) placed inside the mold, the patterns on the mold core (1) can be formed on the inner surface of the monolithically formed object (3) manufactured during the blow molding process. The present invention is applicable to light-transmittable materials, such as, PS, PC, PMMA, and so on.

As such, the above injection blow molding process does not involve complex and time-consuming steps, and does not require two-process manufacturing, the yield rate and the economical benefit are both improved.

Referring to FIG. 2, the present invention provides a plastic object with inner pattern, which includes: a light-transmittable main body (3), made of a light-transmittable material, having at least an outer surface (31) and an inner surface (32), wherein the outer surface (31) being smooth and the inner surface (32) having predefined pattern (321); the inner surface (32) of the main body (3) surrounding to form a hollow space (33). In the present embodiment, the number of patterns (321) can be plural, either continuous or con-continuous geometrical patterns, or a single image (not shown).

Referring to FIG. 3, FIG. 3 shows an embodiment of the present invention applied to an electronic candle, wherein the main body (3) is a light tube for electronic candle, and the top of the electronic candle light tube is disposed with a concave part (34) for the disposition of a light-emitting device (4) so as to achieve the expected effect of the electronic candle as well as further enhance the esthetics with the patterns (321) on the inner surface (32) of the light tube.

Referring to FIGS. 4-5, FIGS. 4-5 show an embodiment of the present invention applied to a decorative aquatic ball, wherein the main body (3a) is a spherical shape with a lower hole (35a) covered with a bottom cover (5) made of light-transmittable material so as to seal the hollow part (33a) of the main body (3a). As such, the hollow part (33a) can be filled with a fluid (6) and glittering bits (7). In addition, the lower edge of the main body (3a) is connected to a base (8). The base (8) is disposed with a light-emitting device (81), having a light-emitting body (82) disposed underneath the bottom cover (5) so that the light from the light-emitting body (82) can be projected into the hollow part (33a). As such, the fluid (6), glittering bits (7) and patterns (321a) on the inner surface (32a), under the light and reflection, will enrich the esthetics of the aquatic ball.

Referring to FIG. 6, FIG. 6 shows an embodiment of the present invention applied to a light bulb. The main body (3b) is a shell of a light bulb and the pattern (321a) is disposed on the inner surface (32b) at the lower half of the shell. When the light bulb emits light, the light travels to the lower half will be reflected to the upper half so as to provide more luminance.

In summary, the pattern on the inner surface can enhance the reflection of light so as to enhance luminance and decorative results when the present invention is applied to decorative products or lamps.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. Aplastic object with inner pattern, comprising:
a light-transmittable main body, monolithically formed by injection blow molding process, having at least an outer surface and an inner surface, wherein the outer surface being smooth and the inner surface having predefined pattern.

2. The plastic object with inner pattern according to claim 1, wherein the pattern is continuous.

3. The plastic object with inner pattern according to claim 1, wherein the inner surface of the main body surrounds to form a hollow part.

4. The plastic object with inner pattern according to claim 3, wherein the main body is a light tube for electronic candle.

5. The plastic object with inner pattern according to claim 3, wherein the main body is a spherical structure object.

6. The plastic object with inner pattern according to claim 3, wherein the main body is a shell of a light bulb and the pattern is disposed at the lower half of the shell.
